(19) United States
(12) Patent Application Publication
(10) Pub. No.: US 2022/0248630 A1
(43) Pub. Date: Aug. 11, 2022

(54) Dual Zone Sifting Scoop for Sifting Various Size Particles or Materials

(71) Applicant: Carol Ann Michelle, Los Angeles, CA (US)

(72) Inventor: Carol Ann Michelle, Los Angeles, CA (US)

(21) Appl. No.: 17/169,818

(22) Filed: Feb. 8, 2021

(51) Int. Cl. A01K 1/01; B07B 1/02

(52) U.S. Cl. CPC A01K 1/0114; B07B 1/02

(57) ABSTRACT

A device including a front edge section; a back wall section disposed opposite the front edge section; a first sifting area disposed close to the front edge, wherein the first sifting area is configured to separate a first type of particle or material from a litter with a first plurality of slots; a second sifting area disposed at the back wall section, wherein the second sifting area is configured to be operable for separating a second type of particle or material from the litter with a second plurality of slots, wherein the second type or particle or material are larger than the first type of particle or material; and a handle implement for controlling the use of the first and second sifting areas.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to a sifter. More particularly, certain embodiments of the invention relates to a litter box sifter capable of sifting multi-particle size debris.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Typically, as is known in the art, a litter box, sometimes called a sandbox, litter tray, cat pan, litter pan, or catbox, is an indoor feces and urine collection box for cats, as well as rabbits, ferrets, miniature pigs, small dogs—for example beagles and chihuahuas, and other pets that instinctively or through training will make use of such a repository. They are provided for pets that are permitted free roam of a home but who cannot or do not always go outside to excrete their metabolic waste. The litter box is generally filled with a litter box filler which is a loose, granular material that absorbs moisture and odors such as ammonia. The most common material is clay, although recycled paper “pellets” and silica-based “crystal” variants may also be used. A variety of litter box sifters are available in the market for sifting the metabolic waste from the litter material. The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that the sifters available in the art typically include shovels with cutouts on the body. Generally, they are adequate for sifting or scooping the litter boxes, but may allow smaller pieces of debris to fall through the sifters back into the litter box, leaving an unkempt look to the sand. It is believed that incomplete sifting may occur since the cutouts in the body of the sifter are all in one size and the scoops typically have a flat contour. Further, with some sifters the scoop features raised ridges in the sifting area of the scoop which may catch debris that stays trapped between the slots rather than falling through. It will be appreciated by a person with ordinary skill in the art, that though the scoops available in the market may be referred to as heavy duty one can expect that the failure to achieve heavy-duty sifting may be a result of the scoop sizes being relatively small and shallow thought made of metal or scoops being made of easily breakable plastic.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a prior art litter sifter;

FIG. 2 illustrates a prior art litter sifter

FIG. 3 illustrates top-view of an exemplary litter sifter, in accordance with an embodiment of the present invention;

FIG. 4 illustrates cross-sectional side-view of an exemplary litter sifter, in accordance with an embodiment of the present invention;

FIG. 5 illustrates top-view of an exemplary litter sifter, in accordance with an embodiment of the present invention;

FIG. 6 illustrates front-view of an exemplary litter sifter, in accordance with an embodiment of the present invention;

FIG. 7 illustrates back-view of an exemplary litter sifter, in accordance with an embodiment of the present invention;

FIG. 8 illustrates side-view of an exemplary litter sifter, in accordance with an embodiment of the present invention; and

FIG. 9 illustrates a flowchart of an exemplary method for sifting of litter in a litter box using the sifter described herein, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *1344 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, in re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s)/way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

As referred to herein, the term litter may refer to litter material that include a loose, granular material that may absorb moisture and odors such as ammonia, for example, sand, gravel, clay, crystals, gel crystals, commercial litter, other materials including clumping and non-clumping material known to be used as litter material, and the like. Some litter material may also contain baking soda to absorb such odors. The litter sifter disclosed herein may also be referred to as cat litter scoop, dog litter scoop, pet litter scoop, animal litter scoop, and the like. The litter sifter may also be referred to as scoop, shovel, grate, trowel, spade, dipper, bail, spoon, ladle, rake, and the like.

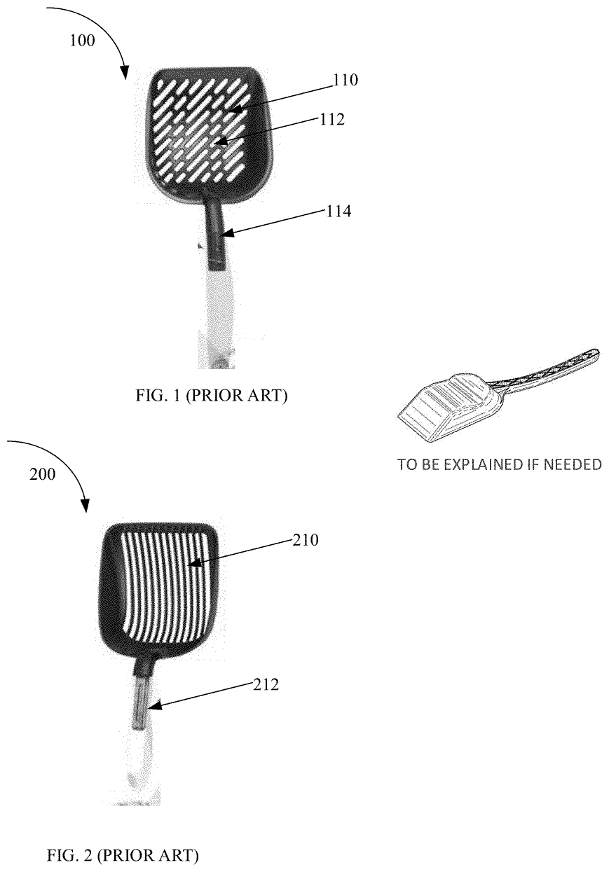

Embodiments of the invention described herein, relate to a litter sifter. More particularly, certain embodiments of the invention relates to a litter box sifter capable of sifting multi-particle size debris. In one embodiment, the present invention discloses a heavy-duty litter box sifter. The litter box sifter may be capable of removing relatively smaller particles of debris from the litter than is typically possible with sifters currently available in the market as described with reference to FIG. 1 (prior art) and FIG. 2(prior art). FIG. 1 illustrates a prior-art litter sifter 100. The sifter 100 includes slots of type 110 and 112, and a handle 114 that has stub in hollow rubber. The slots 110 and 112 are shown to have different lengths but having the same width. FIG. 2 illustrates another prior-art litter sifter 200. The sifter 200 includes slots of type 210 and a handle 212 that has stub in hollow plastic. The slots 210 have the same length and the same width. Accordingly, in various embodiments, the present invention provides a litter sifter with at least wo different sized mesh filtering areas, a deeper volume receptacle for the wider mesh area and a relatively shallow volume receptacle for the finer mesh area. The present invention also provides a method of more effectively cleaning pet litter boxes. The litter sifter disclosed herein may provide a variety of advantages as mentioned herein below.

In one embodiment, the litter sifter disclosed herein may provide a heavy-duty litter box sifting, especially in multiple pet and multiple litter box situations. In one embodiment, the scoop may be cast from solid aluminum from end to end, with a wider and deeper shovel portion, allowing for more than one scooping pass before needing to empty the scoop. In one embodiment, the litter sifter disclosed herein may assist to remove smaller particles of debris from the sand than is possible with a standard scoop. The litter sifter disclosed herein, in one exemplary embodiment, includes a two-level design of the sifter that offers not only the utility of a standard sifter with higher volume, but also a finishing scoop in the front level of the scoop that includes a smaller volume section with smaller space between the sifting cut-outs. This may allow a user to make a final pass of the top layer of sand picking up the smaller pieces of sand that fall through the standard spaced cut-outs. In addition, the smaller particles may be held to the front of the sifter in the finishing section i.e., in the front section, keeping them from rolling toward the back section of the sifter where the cut-outs may be spaced farther apart as needed for faster scooping.

In one embodiment, the present invention provides a litter sifter with a longer reach to be able to sift the far side of a litter box on larger boxes or when leaning over one litter box to access another box, without straining one's back. This is achieved by providing a longer handle that may help to reduce the strain on the back of the user. It will be appreciated by a person with ordinary skill in the art, in light of and in accordance with the teachings of the present invention, that the handle length may only be a few inches longer, because if the handle were too long, it may be difficult to empty the scoop into a receptacle without pulling a user's arm back significantly.

In one embodiment, the present invention provides a litter sifter with an ability to scoop in the hard to access corners of the litter box where two sides meet. It will be appreciated by a person with ordinary skill in the art, in light of and in accordance with the teachings of the present invention, that cleaning the corners of litter boxes may typically be difficult, but with the litter sifter disclosed herein, the front edge corners are almost squared off, though slightly rounded, to allow access to those hard to clean corners.

In one embodiment, the present invention provides a litter sifter with an ability to dig into the litter effortlessly and scrape the bottom of the litter box to remove any wet litter stuck to the bottom surface of the box. It will be appreciated by a person with ordinary skill in the art, in light of and in accordance with the teachings of the present invention, that having a slick clean edge on the front of the litter sifter disclosed herein may allow a user to cut through the litter like a knife through butter. Accordingly, the thin front edge may help to run along the bottom floor of the litter box where wet sand can accumulate and stick.

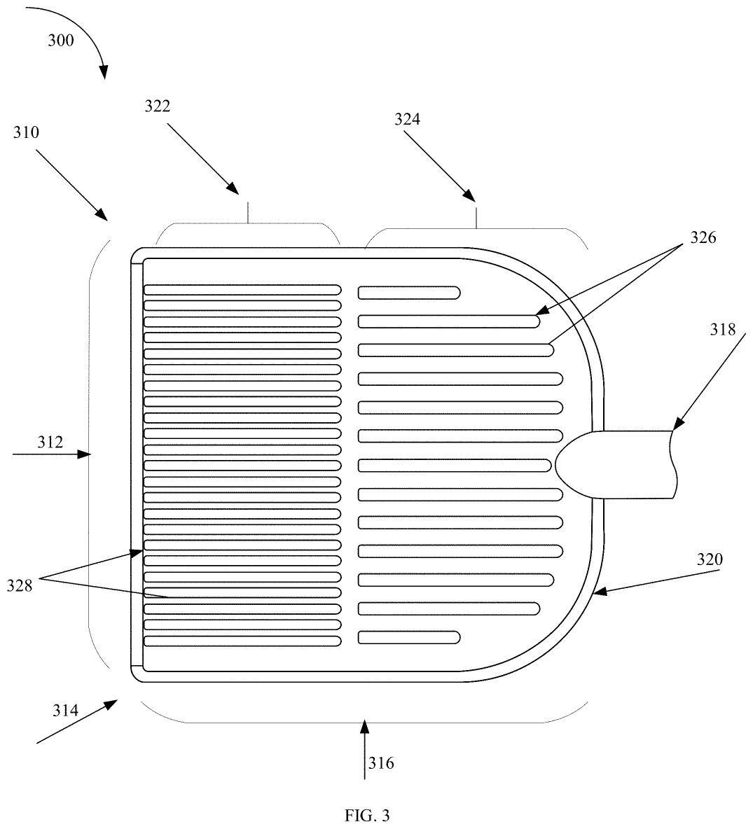

In one embodiment, the litter sifter disclosed herein is designed to be able to lift larger amount of sand and litter box debris without the shovel bending or breaking particularly for litter boxes that may experience heavy use requiring more sifting. The litter sifter disclosed herein is wider and deeper allowing a user to make more than one pass, collecting more debris before needing to empty the scoop. The larger amount of debris that the litter scoop described herein holds is provided by solid construction (as described with reference to FIG. 3-7 below) that will not break or drop its contents until the user chooses to empty it.

In one embodiment, the litter sifter disclosed herein is designed to be comfortable to hold when sifting. The litter sifter described herein may include a soft grip that will keep the user's hand comfortable while sifting the litter box. In one exemplary embodiment, a vinyl/rubber grip may be solidly adhered over the solid metal handle of the sifter.

In one embodiment, the litter sifter disclosed herein is designed to be able to pick up heavy larger pieces of debris while doing multiple passes between emptying. This is achieved by having a large volume portion in the sifter as described above.

In one embodiment, the litter sifter disclosed herein is designed to be able to clean the scoop without the fuss of getting particles out of nooks and crannies. The lines of the litter sifter described herein are simple for fast and easy cleaning. The litter sifter has a flat ridge-less design that prevents chunks of debris from becoming caught between the cut-outs or slots. In another embodiment, the litter sifter may include at least two different sized mesh filtering areas having slots/cut-outs stacked on top of each other and arranged in parallel. The finer mesh filtering area may include a shallower volume/receptacle and the wider mesh filtering area may include a deeper volume/receptacle.

Accordingly, FIG. 3 illustrates top-view of an exemplary litter sifter, in accordance with an embodiment of the present invention. As shown in FIG. 3, the litter sifter 300 includes a front edge 312 having a first corner 310 and a second corner 314, a back wall 320, a handle 318, and a body portion of the sifter 316 which may be distributed at least into two portions including a first sifting section 322 for separating finer particles from the litter which may be disposed closer to the front edge 312, and a second sifting section 324 for separating relatively larger particles from the litter which may be disposed closer to the back wall 320. The front edge corners 310, 314 are almost squared off, though slightly rounded, to allow access to the hard to clean corners as described hereinabove.

In one embodiment, the first sifting section 322 may include a plurality of slots 328 having a predetermined length in a range of from about 5 centimeters (cm) to about 6 cm and a predetermined width in a range of from about 2.5 millimeters (mm) to about 4 mm. In another embodiment, the first sifting section 322 may include slots 328 having a length in a range of from about 5 cm to about 6 cm and a width in a range of from about 4.5 mm to about 6 mm. In yet another embodiment, the first sifting section 322 may include a predetermined number of slots 328 having a length in a range of from about 5 cm to about 6 cm and a width in a range of from about 5 mm to about 7 mm. In one embodiment, the first sifting section 322 may include slots 328 having a length of about 6 cm and a width of 20 percent narrower than that of the slots of the second sifting section.

It will be appreciated by a person with ordinary skill in the art, in light of and in accordance with the teachings of the present invention, that the particles sifted by the first sifting section 322 and the second sifting section 324 may both have a particle size larger than the particle size of the litter used in a litter box for a pet. In one embodiment, the second sifting section 324 may include slots 326 having a length in a range of from about 7 cm to about 9 cm and a width in a range of from about 3 mm to about 5 mm. In another embodiment, the second sifting section 324 may include a plurality of slots 326 having a length in a range of from about 7 cm to about 9 cm and a width in a range of from about 4 mm to about 6 mm. In yet another embodiment, the second sifting section 324 may include a predetermined number of slots 326 having a length in a range of from about 7 cm to about 9 cm and a width in a range of from about 5 mm to about 6 mm. In one embodiment, the second sifting section 324 may include slots 326 having a length of about 8 cm and a width of about 3/16^{th} of an inch i.e., about 4.762 mm.

In another embodiment, slots 326 and slots 328 are generally arranged in parallel where the predetermined number of slots 326 of the second sifting section is generally stacked to the back of the predetermined number of slots 328 of the first sifting section as shown in FIG. 3. In an alternative embodiment, the first and second sifting sections may include at least two different sized mesh filtering areas where the first sifting section may include a finer sized mesh filtering area and the second sifting section may include a wider sized mesh filtering area and where slots 326 may include the wider sized mesh and slots 328 may include the finer sized mesh.

In one embodiment, the particles sifted by the first sifting section 322 may have an average particle size diameter in a range of from about 1.5 millimeters (mm) to about 3 mm. In another embodiment, the particles sifted by the first sifting section 322 may have an average particle size diameter in a range of from about 2.5 mm to about 4 mm. In yet another embodiment, the particles sifted by the first sifting section 322 may have an average particle size diameter in a range of from about 4 mm to about 6 mm. In one embodiment, the particles sifted by the first sifting section 322 may have an average particle size diameter of about 5 mm.

In one embodiment, the particles sifted by the second sifting section 324 may have an average particle size diameter in a range of from about 4 mm to about 6 mm. In another embodiment, the particles sifted by the second sifting section 324 may have an average particle size diameter in a range of from about 5 mm to about 7 mm. In yet another embodiment, the particles sifted by the second sifting section 324 may have an average particle size diameter in a range of from about 6 mm to about 8 mm. In one embodiment, the particles sifted by the second sifting section 324 may have an average particle size diameter of about 7 mm.

It will be appreciated by a person with ordinary skill in the art, in light of and in accordance with the teachings of the present invention, that the litter sifter described herein provides two-levels of sifting in one litter sifter. The larger back portion with larger sifting slots is for general heavy-duty sifting. The front section of the litter sifter with finer sifting slots focuses on the finishing passes picking up smaller debris. The front section allows the smaller debris to stay in the front section as the user makes a final shallower pass of the litter box. It leaves a cleaner look to the sand and is more thorough than other litter sifters.

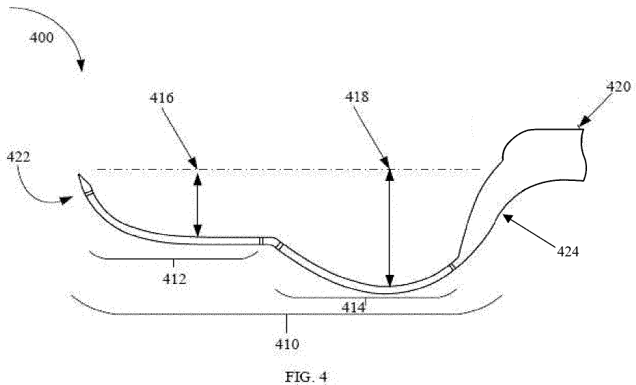

FIG. 4 illustrates a cross-sectional side-view of an exemplary litter sifter, in accordance with an embodiment of the present invention. As shown in FIG. 4 the litter sifter has a body 410 and a handle 420 (partial view of the handle). Along a length of the body the litter sifter may have two distinct portions, a first portion 412 and a second portion 414. First portion 412 disposed near a front end 422 has a depth 416. Second portion 414 disposed near a back end 424 has a depth 418. In one embodiment, the first portion 412 may have a depth in a range of from about 25 mm to about 35 mm. In another embodiment, the first portion 412 may have a depth in a range of from about 30 mm to about 40 mm. In yet another embodiment, the first portion 412 may have a depth in a range of from about 40 mm to about 50 mm. In one embodiment, the first portion 412 may have a depth of about 40 mm.

In one embodiment, the second portion 414 may have a depth in a range of from about 40 mm to about 45 mm. In another embodiment, the second portion 414 may have a depth in a range of from about 45 mm to about 50 mm. In yet another embodiment, the second portion 414 may have a depth in a range of from about 50 mm to about 60 mm. In one embodiment, the second portion 414 may have a depth of about 50 mm.

In one embodiment, the first portion 412 and the second portion 414 may have a depth in a ratio in a range of from about 30-40:50-60. In another embodiment, the first portion 412 and the second portion 414 may have a depth in a ratio in a range of from about 25-35:45-55. In yet another embodiment, the first portion 412 and the second portion 414 may have a depth in a ratio in a range of from about 20-30:40-50. In one embodiment, the first portion 412 and the second portion 414 may have a depth in a ratio of about 25:45.

In some embodiment, first portion 412 and second portion 414 may include at least two different sized mesh filtering areas, each having an outline or surface that generally curves inward like a spoon or an interior of a circle or sphere. A bottom section of first portion 412 forms a first contour coupled to a bottom section of second portion 414 that forms a second contour. The first contour may include a shallower volume/receptacle for the finer mesh area of first portion 412 and the second contour may include a deeper volume/receptacle for the wider mesh area of second portion 414. The rounded shape at the bottom of first portion 412 and second portion 414 provides a smooth surface and may make it easier to clean the surface of the litter sifter.

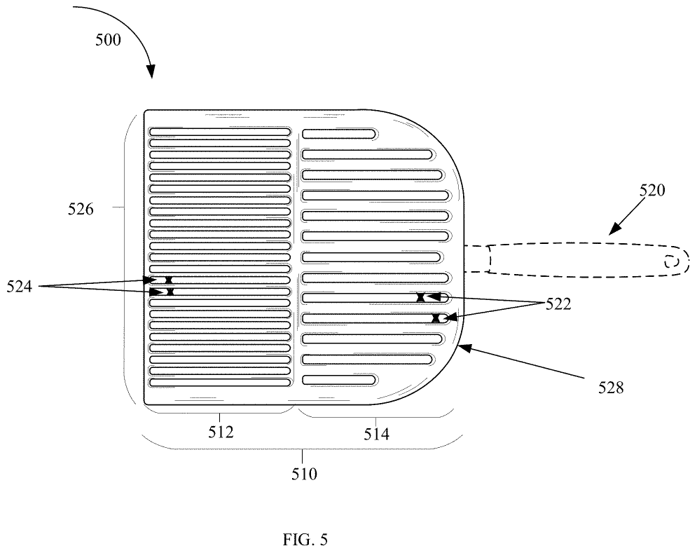

FIG. 5 illustrates top-view of an exemplary litter sifter, in accordance with an embodiment of the present invention. As shown in FIG. 5, the top-view 500 shows a body of a litter sifter 510 having a first portion 512, a second portion 514, and a handle 520 for controlling the use of the two different sized sifting or filtering areas. The first portion 512 includes slots/cut-outs 524 and the second portion 514 includes slots/cut-outs 522. The slots 524 are narrower than the slots 522 providing two different sized sifting or filtering areas as described herein above. It will be appreciated by a person with ordinary skill in the art, in light of and in accordance with the teachings of the present invention, that the litter sifter described herein may in one embodiment, include a handle 520 having a length in a range of from about 6 inches to about 8 inches. In another embodiment, the litter sifter may include a handle having a length in a range of from about 20 inches to about 24 inches. In yet another embodiment, the litter sifter may include a handle having a length in a range of from about 30 inches to about 32 inches. In one embodiment, the litter sifter may include a handle having a length in a range of from about 10 inches to about 16 inches.

In one embodiment, the sidewalls of litter sifter 510 may be elevated to prevent waste matter from falling off and/or contain the waste matter within the litter sifter. In some embodiments, first portion 512 and second portion 514 may include an outline or surface that generally curves inward like a spoon or an interior of a circle or sphere forming the elevated sidewalls operable for holding waste matter.

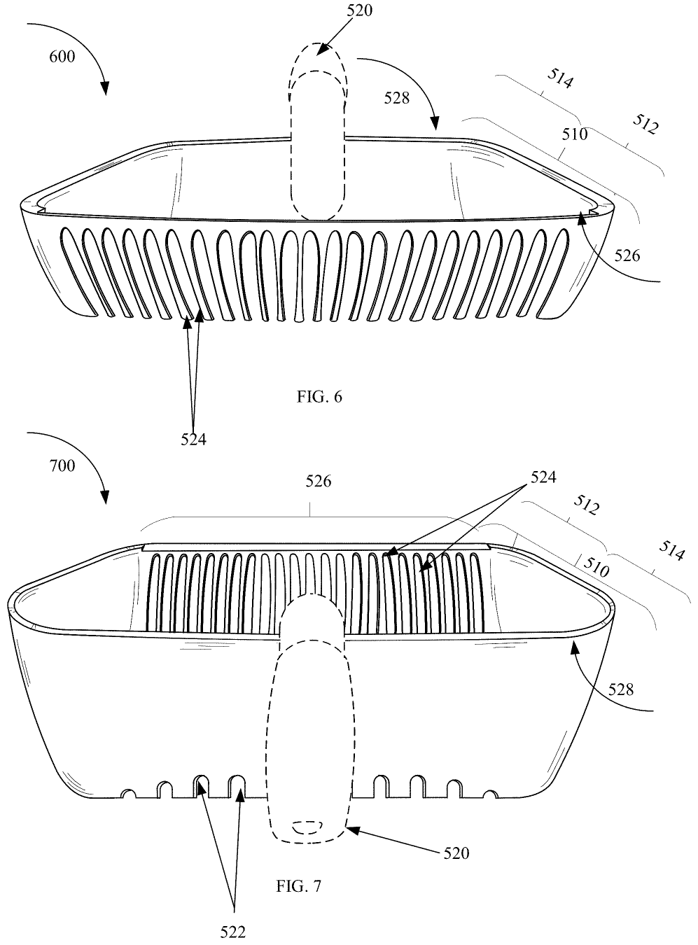

FIG. 6 illustrates front-view 600 of an exemplary litter sifter, in accordance with an embodiment of the present invention. The front-view 600 of the litter sifter shows the side 510 along a length of the litter sifter with a first portion 512 and a second portion 514, the front edge 526 shows the cut-outs 524 formed in a first portion 512 of the litter sifter, and the back edge 528 includes the handle. Cut-outs 524 span the whole length of the first portion 514 starting from a center portion of the litter sifter (not shown in figure) and running up all the way to front edge 526 of the litter sifter.

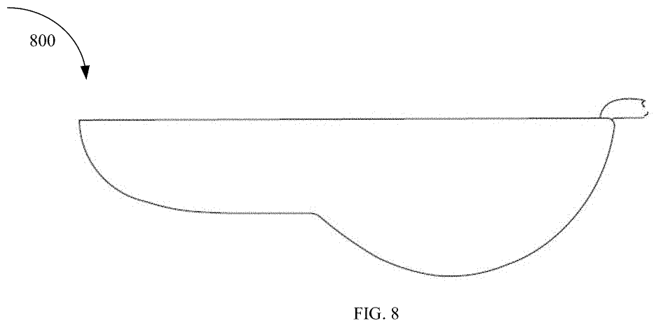

FIG. 7 illustrates a back-view of an exemplary litter sifter, in accordance with an embodiment of the present invention. The back-view 700 of the litter sifter shows the side 510 along a length of the litter sifter with first portion 512 and second portion 514, the front edge 526 shows the cut-outs 524 having a finer mesh filtering area formed in first portion 512 of the litter sifter, and the back edge 528 shows the cut-outs 522 having a wider mesh filtering area that originate from the center of the sifter and move towards a bottom portion (not marked in figure) of the back edge 528 of the litter sifter. The back edge also includes the handle 520. As shown in FIG. 6 and FIG. 7, the front edge may include a thin front edge that may allow a user to cut through the litter like a knife through butter. Accordingly, the thin front edge may help to run along the bottom floor of the litter box where wet sand can accumulate and stick. Also as shown in FIGS. 6 and 7 the litter sifter has more volume to retain the debris after multiple passes.

It will be appreciated by a person with ordinary skill in the art, in light of and in accordance with the teachings of the present invention, that any suitable material may be employed to make the litter sifter described herein. In one exemplary embodiment, the material used to make the litter sifter is aluminum. In one embodiment, the material used to make the litter sifter may have a thickness in a range of from about 1.8 mm to about 2.2 mm. In another embodiment, the material used to make the litter sifter may have a thickness in a range of from about 1.5 mm to about 2.5 mm. In yet another embodiment, the material used to make the litter sifter may have a thickness in a range of from about 1.2 mm to about 2.8 mm. In one embodiment, the material used to make the litter sifter may have a thickness of about 2 mm. FIG. 8 illustrates side-view of an exemplary litter sifter, in accordance with an embodiment of the present invention. As shown in FIG. 8, the side view shows a rounded-off contour of the first portion and second portion of the litter sifter disclosed herein with reference to FIGS. 3-7 above. In one embodiment, the rounded shape provides a smooth surface and may make it easier to clean the surface of the litter sifter.

In one embodiment, the litter sifter may be made by manufacturing a metal die cast. In one exemplary embodiment, if the litter sifter is made of aluminum, molten aluminum may be injected into the form and the custom designed litter sifter may be manufactured. The litter sifter may be polished for burrs, given a high-luster shine (if desired), or have a protective and decorative spray coating applied. In one embodiment, a vinyl handle may cover the solid aluminum handle making it more comfortable and ergonomic for the user. The goal is to have a weight balance between the body of the litter sifter and the handle.

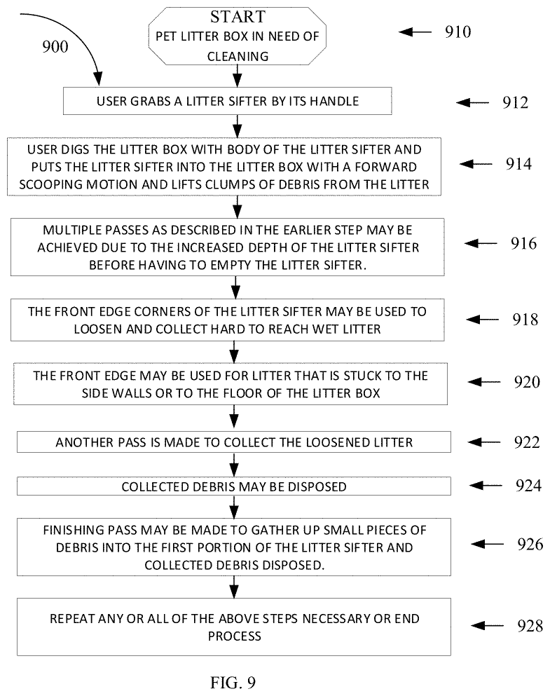

FIG. 9 illustrates a flowchart of an exemplary method for sifting of litter in a litter box using the sifter described herein, in accordance with an embodiment of the present invention. The method may start 910 with a step where a pet litter box may need cleaning. In a first step 912 the method may include grabbing the litter sifter by its handle. In a second step 912 may include digging the litter box with the body of the litter sifter and putting the litter sifter into the litter box with a forward scooping motion, and lifting the clumps of debris up from the sand or litter. In one exemplary embodiment, as mentioned herein above the handle may have a length of about 10 inches to about 12 inches and be made of solid aluminum with an outer vinyl hand grip. The body of the litter sifter may be approximately 6.5 inches to 7 inches when measuring from the front edge to the back edge of the litter sifter as shown in FIG. 3-7.

In a third step 916, multiple passes may be achieved by using the litter sifter prior to having to empty the sifter. This may be achieved due to the higher side walls and overall deeper body of the litter sifter as shown at least with reference to FIGS. 6 and 7. The front first portion of the litter sifter, which is used for sifting finer debris, may in an exemplary embodiment, have a depth of about an inch. The back second portion of the lifter sifter may in an exemplary embodiment have a depth of about 2.5 inches deep. The overall body of the litter sifter is used for general sifting. The bonus feature is that the front first portion provides a finer sifting experience for sifting the finer pieces of debris, leaving the litter box looking cleaner.

In a fourth step 918 to clean the corners of the litter box, the pointy front edge corners of the litter sifter may be used to loosen and collect hard to reach wet litter. In a fifth step 920 the front long, sharp edge of the litter sifter may be used for litter that is stuck to the side walls of the litter box or to the floor of the litter box, to easily scrape loose any debris that is stuck to the surface. In a sixth step 922, another standard sifting pass may be made using the litter sifter to gather this now loosened debris. In a seventh step 924 if the user is ready, the contents of the litter sifter may be emptied into a disposable bag or container. After the large clumps of debris have been removed, in an eighth step 926 the user can make a “finishing” pass with the litter sifter to gather up the small pieces of debris into the first portion of the litter sifter. The user does not need to dig deep, but instead, make a shallower surface pass holding the scoop at a slightly more vertical angle focusing on the top layer of the litter. This allows the user to capture smaller pieces of debris into the front section of the scoop which is designed for finer sifting and then the smaller debris may be emptied into the disposable bag or container for easy disposal. In a ninth step 928, any of the steps about may be repeated if necessary, to get a clean litter in the litter box before ending the process.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a dual zone sifting scoop according to the present invention will be apparent to those skilled in the art. Various aspects of the invention have been described above by way of illustration, and the specific embodiments disclosed are not intended to limit the invention to the particular forms disclosed. The particular implementation of the dual zone sifting scoop may vary depending upon the particular context or application. By way of examples and not limitation, the dual zone sifting scoop described in the foregoing were principally directed to implementations requiring heavy-duty sifting in litter boxes; however, similar techniques may instead be applied to separating extraneous matter from cereals, or for separating mixed materials, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre AIA) or 35 USC 112(f) post-AIA. Otherwise, no limitations from the specification are to be read into any claims, unless those limitations are expressly included in the claims.

What is claimed is:

1. A device comprising:
a front edge section;
a back wall section, said back wall section being disposed opposite said front edge section;
a first sifting area, said first sifting area being disposed close to said front edge, wherein said first sifting area is configured to be operable for separating a first type of particle or material from a litter;
a first plurality of slots disposed on said first sifting area that is configured to separate the first type of particle or material from the litter;
a second sifting area, said second sifting area being disposed at said back wall section, wherein said second sifting area is configured to be operable for separating a second type of particle or material from the litter, wherein the second type or particle or material are larger than the first type of particle or material;
a second plurality of slots disposed on said second sifting area that is configured to separate the second type of particle or material from the litter; and
a handle implement, said handle implement is into engagement with said back wall section.

2. The device of claim 1, in which said front edge section comprises:
a first corner;
a second corner; and
wherein said first corner and second corner are configured to allow access to hard to clean corners.

3. The device of claim 2, in which said front edge further comprises a substantially thin front edge that is configured to cut through the litter.

4. The device of claim 2, in which said first plurality of slots comprises a first predetermined slot length and width.

5. The device of claim 4, in which said second plurality of slots comprises a second predetermined slot length and width, wherein said second slot width is wider than said first slot width.

6. The device of claim 4, in which said first slot length comprises about 5 cm to about 6 cm and first slot width comprises about 2.5 mm to about 4 mm.

7. The device of claim 6, in which said second slot length comprises about 7 cm to about 9 cm and said second slot width comprises about 4 mm to about 6 mm.

8. The device of claim 4, in which said first sifting area further comprises a first contour having an outline or surface that generally curves inward like a spoon or an interior of a circle or sphere, said first contour further having a first predetermined depth.

9. The device of claim 5, in which said second sifting area further comprises a second contour having an outline or surface that generally curves inward like a spoon or an interior of a circle or sphere, said second contour further having a second predetermined depth, wherein said second predetermined depth is substantially deeper than said first predetermined depth.

10. The device of claim 9, in which said first predetermined depth comprises about 25 mm to about 35 mm, and in which said second predetermined depth comprises at least 40 mm to about 45 mm.

11. The device of claim 9, in which said first contour and said second contour are coupled at a center of said front edge section and said back wall section.

12. The device of claim 1, in which said handle implement comprises at least one of a stub in hollow plastic and an aluminum handle.

13. The device of claim 12, further comprises a vinyl or rubber grip adhered over said aluminum handle, wherein said vinyl or rubber grip is operable for comfortable and ergonomic use.

14. The device of claim 13, in which said handle implement further comprises a length from at least one of about 6 inches to about 8 inches, about 10 inches to about 16 inches, about 20 inches to about 24 inches, and about 30 inches to about 32 inches. (giving a smaller option, if OK)—Since all of these size ranges were described in the detailed description, I amended this claim and claim 20 to include all of these length options.

15. A device comprising:
a front section;
means for slicing through litter, said slicing means being disposed on said front section;
a back wall section, said back wall section being disposed opposite said front edge section;
means for accessing hard to clean corners disposed at said front section;
means for separating a first type of particle or material from a litter;
means for separating a second type of particle or material from the litter, wherein the second type or particle or material are larger than the first type of particle or material;
means for controlling the separating of the first and second type of particle or material; and
means for providing comfort when using said controlling means.

16. A device comprising:
a front edge section, in which said front edge further comprises a thin front edge that is configured to cut through litter;
a first corner and a second corner, wherein said first corner and second corner are configured to be slightly rounded to allow access to hard to clean corners;
a back wall section, said back wall section being disposed opposite said front edge section;
a first sifting area, said first sifting area being disposed close to said front edge, wherein said first sifting area is configured to be operable for separating a first type of particle or material from a litter;
a first plurality of slots disposed on said first sifting area, said first plurality of slots is configured to separate the first type of particle or material from the litter;
a first contour disposed on said first sifting area, said first contour having an outline or surface that generally curves inward like a spoon or an interior of a circle or sphere, said first contour further having a first predetermined depth;
a second sifting area, said second sifting area being disposed close to said back wall, wherein said second sifting area is configured to be operable for separating second type of particle or material from the litter, wherein the second type or particle or material are larger than the first type of particle or material;
a second plurality of slots disposed on said second sifting area that is configured to separate the second type of particle or material from the litter;
a second contour disposed on said second sifting area, said second contour having an outline or surface that generally curves inward like a spoon or an interior of a circle or sphere, said second contour further having a second predetermined depth, wherein said second predetermined depth is substantially deeper than said first predetermined depth; and
a handle implement, said handle implement is into engagement with said back wall, in which said handle implement comprises at least one of a stub in hollow plastic and an aluminum handle, wherein said handle implement is configured to control the sifting of said first and second sifting areas.

17. The device of claim 16, in which said first plurality of slots comprises a first slot length and width, in which said first slot length comprises about 5 cm to about 6 cm and first slot width comprises about 2.5 mm to about 4 mm.

18. The device of claim 17, in which said second plurality of slots comprises a second slot length and width, wherein said second slot width is wider than said first slot width, in which said second slot length comprises about 7 cm to about 9 cm and said second slot width comprises about 4 mm to about 6 mm.

19. The device of claim 16, in which said predetermined first depth comprises about 25 mm to about 35 mm and said predetermined second depth comprises about 40 mm to about 45 mm.

20. The device of claim 16, further comprises a vinyl or rubber grip adhered over said aluminum handle, wherein said vinyl or rubber grip is configured to be operable for comfortable and ergonomic use, in which said handle implement further comprises a length from at least one of about 6 inches to about 8 inches, about 10 inches to about 16 inches, about 20 inches to about 24 inches and about 30 inches to about 32 inches.
